(19) United States
(12) Patent Application Publication
(10) Pub. No.: US 2015/0183407 A1
(43) Pub. Date: Jul. 2, 2015

(54) MULTI-FUNCTIONAL CLEANER

(71) Applicant: Chung Ho PAK, Daegu-shi (KR)

(72) Inventor: Chung Ho PAK, Daegu-shi (KR)

(21) Appl. No.: 14/539,390

(22) Filed: Nov. 12, 2014

(30) Foreign Application Priority Data
Dec. 26, 2013 (KR) 10-2013-0164190

(51) Int. Cl. B60S 3/04; A47L 7/00; B60S 3/06

(52) U.S. Cl. CPC B60S 3/042; B60S 3/066; A47L 7/0076

(57) ABSTRACT

A multi-functional cleaner comprises a driving means having a motor to generate a dynamic force, an output shall projected from the driving means through a center of a washing body having a first cap hole into which a dust collector or a cap may be detachably coupled, a driving gear coupled to the output shaft, a disc coupled to the driving gear, and a brush member coupled to the disc, wherein the output shaft is rotated to rotate the disc, and wherein as the cap is coupled into the first cap hole, an inside of the washing body is prevented from being exposed.

### CROSS-REFERENCE TO RELATED APPLICATIONS

This patent application claims priority under 35 U.S.C. §119 to Korean Patent Application No. 10-2013-0164190, filed on Dec. 26, 2013, in the Korean Intellectual Property Office, the disclosure of which is incorporated by reference herein in its entirety.

### TECHNICAL FIELD

The inventive concept relates to a multi-functional cleaner, and more specifically, to an apparatus that may be adopted in an apparatus that may mechanically wash the outer surface of a vehicle to clean the wheels of the vehicle and that may function as a vacuum cleaner.

### DISCUSSION OF RELATED ART

The general automatic car washing machine washes the front, top, rear, and left and right sides of a vehicle by rotating multiple brushes installed vertically and horizontally using sensors.

Recent car washing systems come with as wheel washer to clean the wheels or tires of a vehicle.

The wheel washer rotates only in a single direction and has difficulty in fully clearing out contaminants or dirt, and the brush marks left after washing may make the vehicle look worse.

Further, the dust or sand stuck in the brushes while washing may cause the brushes to be easily worn or damaged when the brushes are brought in frequent contact with the surface of vehicle. Such brushes are typically formed in a single body type, and thus, the whole body should be replaced in order to fix a damaged brush.

Further, the conventional automatic car washing machine lacks a polishing function, and thus, use of a polishing tool or hiring an expert is required for polishing.

However, the polishing tool is too heavy (about 10 kg) for a non-expert to use, and hiring a skilled person costs a lot.

The general vacuum cleaner, whatever type it is, should be equipped with a dust filter for collecting dust sucked in through a vacuum generator. The dust filter needs to be replaced when fully filled with dust.

It is uncomfortable and unsanitary for the user to directly touch the dust filter with his hands.

The vacuum cleaner with a main body and a dust collector integrally formed with each other is too bulky.

The above-mentioned car washing machine and the vacuum cleaner, each, have their own limited purposes, and purchase of the both puts more financial burdens to the user. Further, the user would require more space to store them.

### PRIOR TECHNICAL DOCUMENTS

### Patent Documents

(Patent Document 0001) Korean Patent Application Publication No. 10-2012-0063899

### SUMMARY

According to an embodiment of the present invention, a multi-functional cleaner comprises a driving means having a motor to generate a dynamic force, an output shaft projected from the driving means through a center of a washing body having as first cap hole into which a dust collector or a cap may be detachably coupled, a driving gear coupled to the output shaft, a disc coupled to the driving gear, and a brush member coupled to the disc. The output shaft is rotated to rotate the disc, and as the cap is coupled into the first cap hole, an inside of the washing body is prevented from being exposed.

The washing body may further includes a second cap hole, a plurality of vacuum hoses coupled into the first cap hole and the second cap hole, respectively. A plurality of vacuum pads may be coupled to respective ends of the plurality of vacuum hoses.

The driving means may include two or more second fastening pins, and the washing body may include two or more pin holes through which the second fastening pins may be inserted to fasten the washing body to the driving means.

A spring may be provided between the driving means and each of the second fastening pins.

A first fastening pin may be provided to allow the disc to be attached to the driving gear or to be detached from the driving gear. A spring may be provided under the first fastening pin.

A first coupling part may be protruded from an outer circumferential surface of the washing body to allow a washing cap to be coupled to the washing body, the washing cap including two parts that may be separated from each other with respect to a central line. The washing cap may include a detergent inserting hole through which a detergent may be introduced from an outside. A packing and a cap may be sequentially coupled into the detergent inserting hole to prevent the detergent from leaking out.

Two adjusting members may be further provided at two sides of the washing cap, each of the adjusting members having a fastening handle, a gear engaged with the fastening handle, a fastening shaft coupled with the gear through a center of the gear, and a fastening piece coupled with an end of the fastening shaft. Each adjusting member may be configured so that as the fastening handle is rotated, the gear may be rotated to induce the fastening shaft to move forwards or rearwards such that the fastening piece is tightly fastened to a frame of an adjacent vehicle to prevent the washing cap from moving.

The washing cap may include a second coupling opening for coupling with a vacuum plate, the vacuum plate having a first side coupled with a dust collector and a second side opposite the first side, the second side of the vacuum plate coupled with a suction hose. An intake port may be coupled to an end of the suction hose.

The washing cap may include two or a more wires each having a hook at an end thereof.

### BRIEF DESCRIPTION OF DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a perspective view illustrating a multi-functional cleaner according to an embodiment of the inventive concept;

FIG. 2 cross-sectional view taken along line A-“A” of FIG. 1;

FIG. 3 is a view illustrating an example of assembling a multi-functional cleaner, according to an embodiment of the inventive concept;

FIG. 4A is a cross-sectional view of a driving gear, taken along line B-“B” according to an embodiment of the inventive concept, and FIG. 4B is a view illustrating an example of assembling a driving gear and a driving means according to an embodiment of the inventive concept;

FIG. 5 is a perspective view illustrating a driving means and a washing body according to an embodiment of the inventive concept;

FIG. 6 is a cross-sectional view of a multi-functional cleaner, taken along line C-“C” according to an embodiment of the inventive concept;

FIG. 7 is a view illustrating an example of assembling a driving means and a washing body according to an embodiment of the inventive concept;

FIG. 8 is a view illustrating an example of assembling a driving means and a second fastening fin according to an embodiment of the inventive concept;

FIG. 9 is a view illustrating an example driving means and an example second fastening fin according to an embodiment of the inventive concept;

FIG. 10 is a view illustrating an example of assembling a washing cap and a multi-functional cleaner according to an embodiment of the inventive concept;

FIG. 11 is a view illustrating an example in which a multi-functional cleaner is applied to a tire according to an embodiment of the inventive concept;

FIG. 12 is a view illustrating an example in which fastening screw is coupled to a multi-functional cleaner according to an embodiment of the inventive concept;

FIG. 13 is a perspective view illustrating an adjusting screw as illustrated in FIG. 12, according to an embodiment of the inventive concept;

FIG. 14 is a view illustrating an example of assembling a vacuum plate and a dust collector according to an embodiment of the inventive concept;

FIG. 15 is a view illustrating an example of coupling a suction hose to a dust collector according to an embodiment of the inventive concept;

FIG. 16 is a view illustrating an example of assembling a vacuum pad and a vacuum hose according to an embodiment of the inventive concept; and

FIG. 17 is a view illustrating an example of assembling wire rings with a multi-functional cleaner according to an embodiment of the inventive concept.

### DETAILED DESCRIPTION OF EMBODIMENTS

Hereinafter, exemplary embodiments of the inventive concept will be described in detail with reference to the accompanying drawings. The inventive concept, however, may be modified in various different ways, and should not be construed as limited to the embodiments set forth herein. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

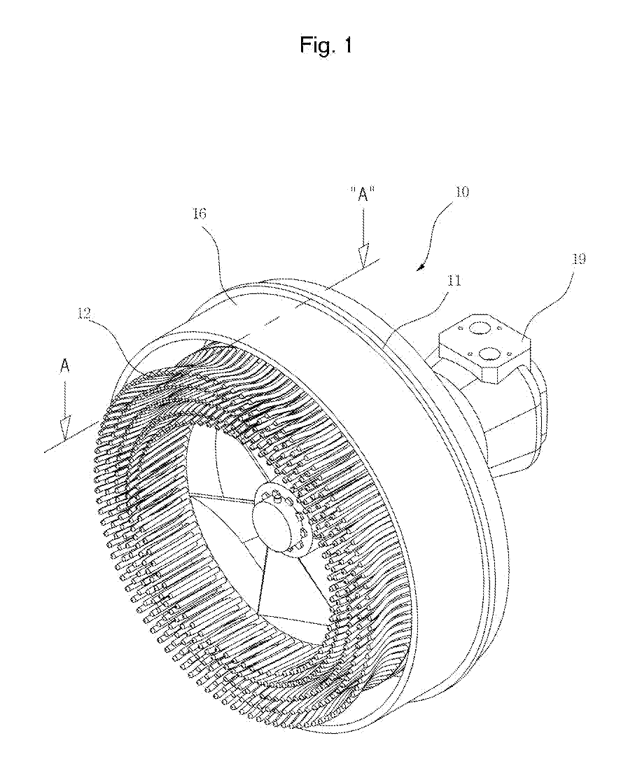

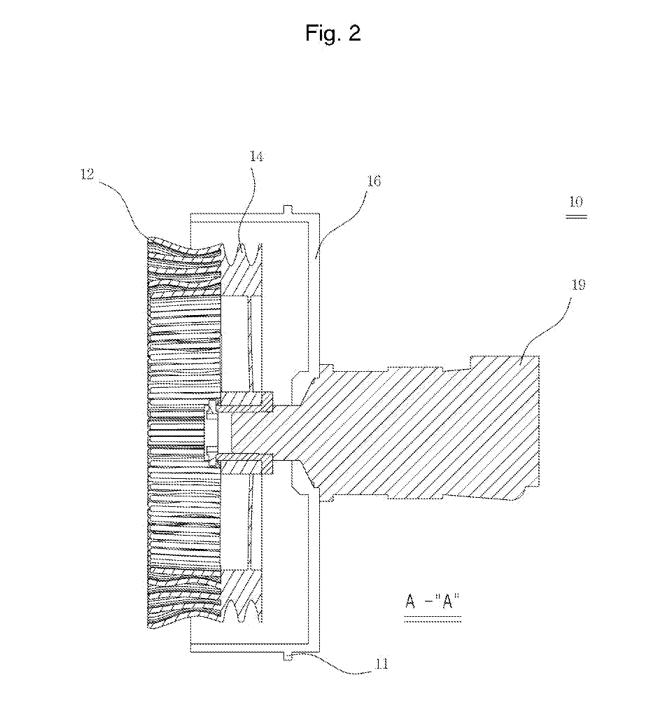

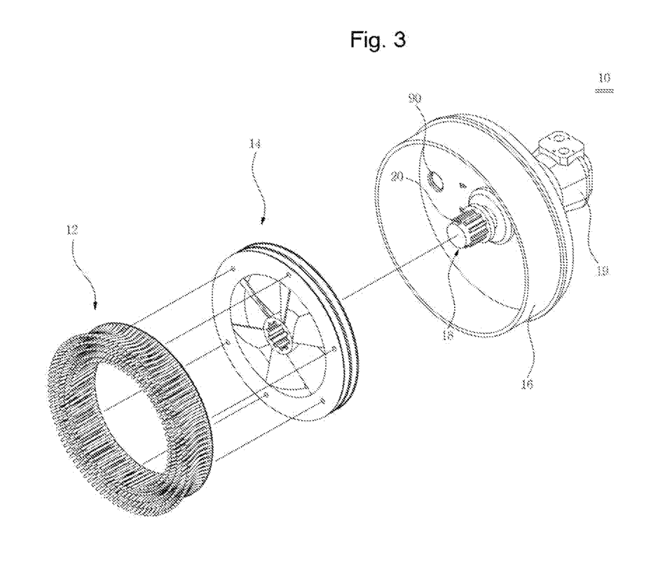

FIG. 1 is a perspective view illustrating a multi-functional cleaner according to an embodiment of the inventive concept. FIG. 2 is a cross-sectional view taken along line A-“A” of FIG. 1. FIG. 3 is a view illustrating an example of assembling a multi-functional cleaner, according to an embodiment of the inventive concept.

According to an embodiment of the inventive concept, a multi-functional cleaner 10 provides various functions.

The multi-functional cleaner 10 includes a driving means 19 having a motor that may rotate in a forward direction or rearward direction to generate a dynamic force, an output shaft 17 coupled with the driving means 19 through a center of a washing body 16, a driving gear 18 coupled to the output shaft 17, a disc 14 coupled to the driving gear 18, and a brush member 12 coupled to the disc 14.

Although an example in which the driving means 19 included in the multi-functional cleaner 10 to wash the outer surface or wheels of vehicle is described, embodiments of the inventive concept are not limited thereto. For example, the driving means 19 may be independently used as a replacement for a power tool or to perform other types of work.

The brush member 12 may be formed of fabric or may have multiple protrusions. For example, a brush member 12 with multiple protrusions may be replaced with a fabric brush member 12 for polishing after washing.

Further, a long handle (not shown) may be connected with the multi-functional cleaner 10 to offer better manipulation and more functions. For example, the user may use a long-handle connected multi-functional cleaner 10 for cleaning or polishing the bonnet or trunk of vehicle or roof of a home.

The multi-functional cleaner 10 may function as a vacuum cleaner.

For example, a dust collector 42 may be coupled with the multi-functional cleaner 10 through a cap hole 90 formed through the washing body 16. The brush member 12 may, at least partially, function as a dust filter. Accordingly, the multi-functional cleaner 10 may be used as a vacuum cleaner. When the dust collector is not coupled, a cap 34 may be coupled into the cap hole 90 to prevent exposure of the inside of the washing body 16. For example, foreign substances may enter the washing body 16 unless the cap hole 90 is blocked while the outer surface of vehicle is washed, thus causing a malfunction of the multi-functional cleaner 10. To address this issue, the cap 34 may be coupled into the cap hole 90 to prevent the inside of the washing body 16 from being exposed to the outside.

The driving gear 18 may be detachably coupled to the output shaft 17, and the disc 14 coupled with the driving gear 18 is rotated together with the brush member 12. The disc 14 and the brush member 12 may be detached, thus allowing for comfortable exchange and a storing space.

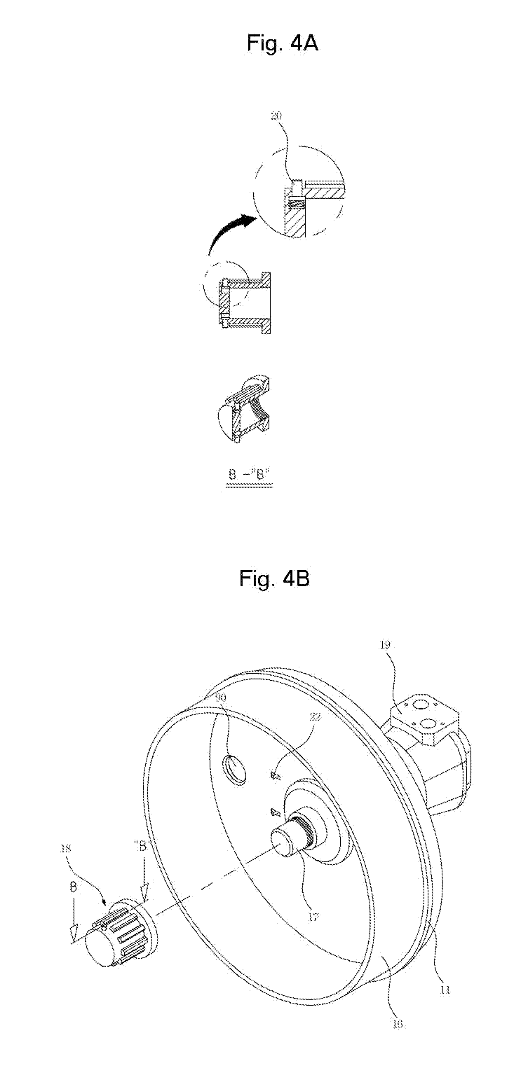

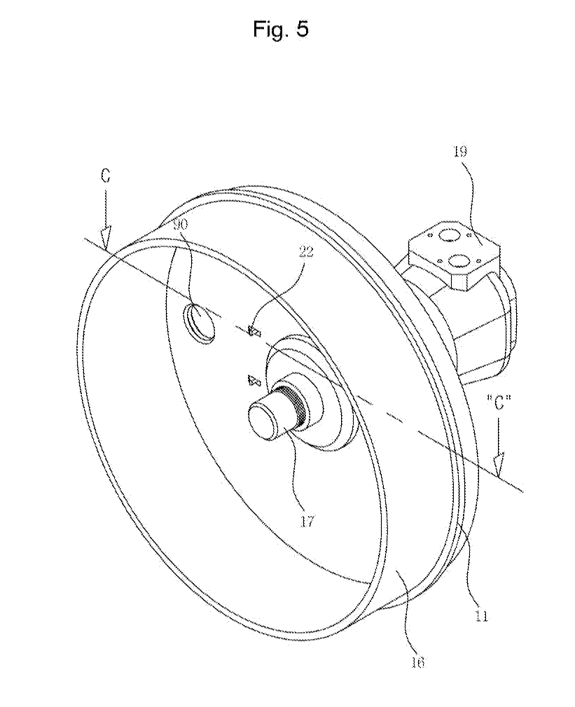

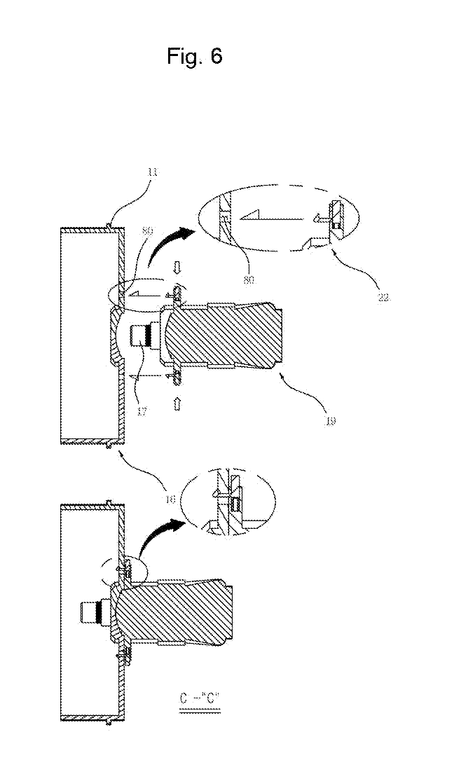

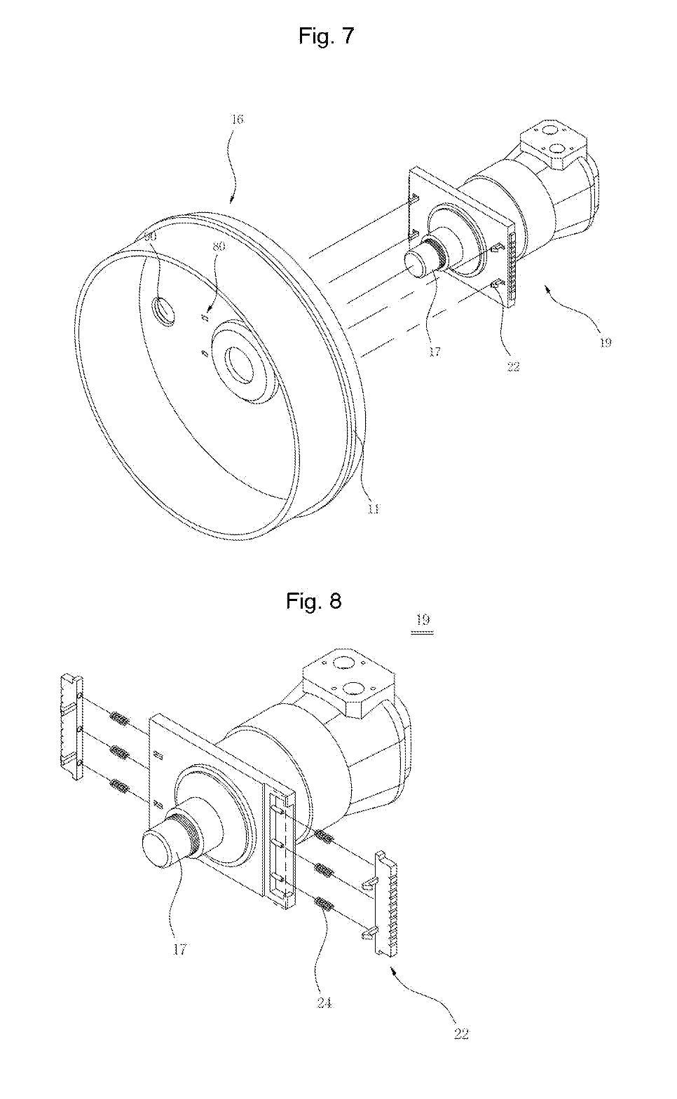

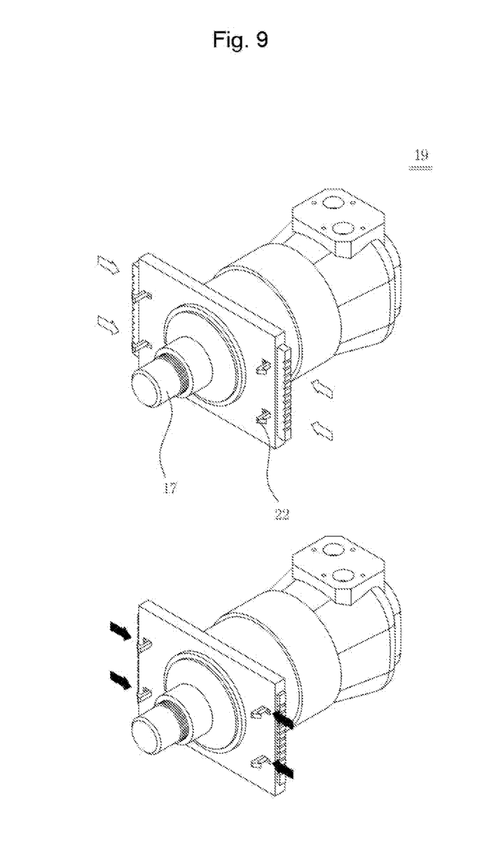

As shown in FIGS. 4 to 9, each component may be detachably provided, thus providing easier exchange thereof while offering a storing space.

For example, as shown in FIG. 4, a spring 24 is placed under a first fastening pin 20 provided at an upper end of the driving gear 18.

Specifically, a portion of the first fastening pin 20, projected from the driving gear 18, is pushed down while the disc 14 is coupled into the driving gear 18, and the projected portion of the first fastening pin 20 is pushed up by the spring 24 when the coupling between the disc 14 and the driving gear 18 is complete, preventing the disc 14 from being separated from the driving gear 18 while the multi-functional cleaner 10 is in operation. For example, the first fastening pin 20 fastens the disc 14 to the driving gear 18.

As shown in FIGS. 5 to 9, the driving means 19 includes at least two second fastening pins 22.

A spring 24 is positioned between the driving means 19 and each second fastening pin 22 to enable the second fastening pin 22 to move up and down.

For example, each second fastening pin 22 may be coupled into a pin hole 80 formed in the washing body 16 to couple the driving means 19 with the washing body 16. The second fastening pins 22 detachably support the driving means 19 and the washing body 16.

Specifically, the second fastening pins 22 may tightly hold the washing body 16 to the driving means 19.

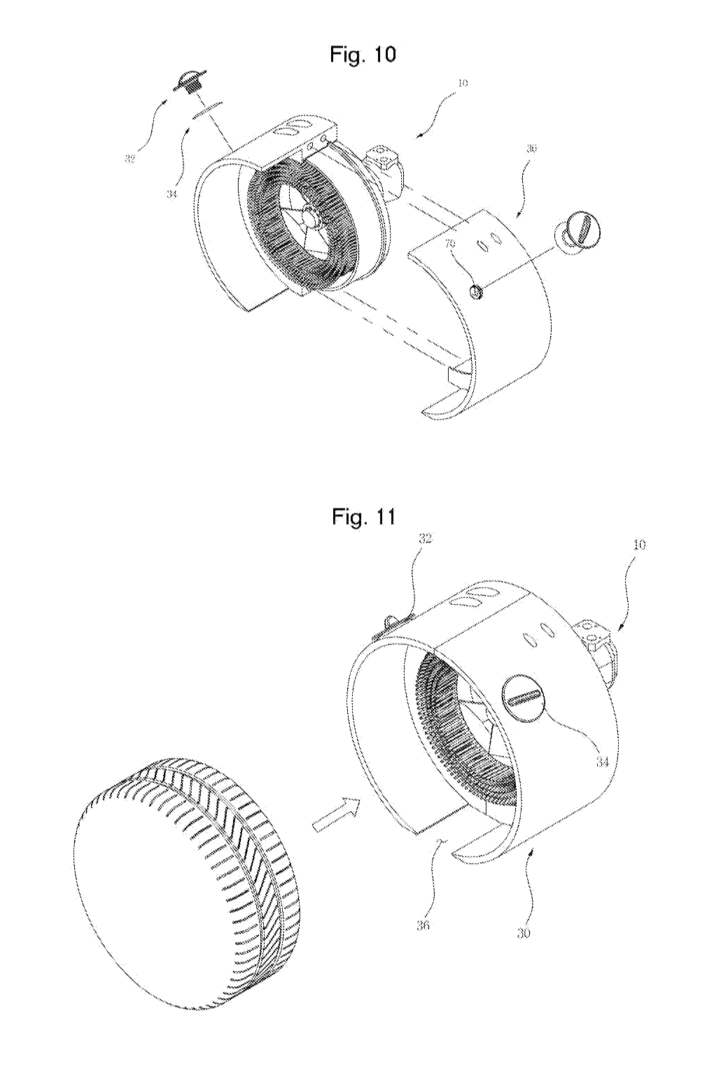

As shown in FIG. 10, the washing body 16 includes a first coupling part 11 projected from the outer surface thereof.

The first coupling part 11 couples a washing cap 3 to the washing body 16.

For example, the washing cap 30 may be divided into two parts with respect to a central line, but not formed as a single body.

The washing cap 30 may be coupled to the washing body 16 in various manners, including, but not limited to, bolt-nut couplings.

The washing cap 30 may offer easier washing or polishing of vehicle wheels.

The washing cap 30 may include a detergent inserting hole 70 through which a detergent may be easily inserted into the washing body 16 from the outside. The washing cap 30 may include a space for receiving a detergent or polish (e.g., wax).

A packing 32 and a cap 34 are sequentially coupled into the detergent inserting hole 70 of the washing cap 30, preventing the exposure of inside and the spatter of detergent while the multi-functional cleaner 10 is in operation.

According to an embodiment of the inventive concept, a water jet means may be alternatively or optionally coupled to the multi-functional cleaner 10 to wash or polish the vehicular wheels.

Referring to FIG. 11, the washing cap 30 coupled to the washing body 16 includes a space to accommodate a tire. The washing cap 30 surrounds the washing body 16 to allow for comfortable wheel washing.

The washing cap 30 includes a second coupling opening 36 at a position corresponding to where the tire meets the ground. The second coupling opening 36 supports a lower end of the multi-functional cleaner 10 so that the multi-functional cleaner 10 may be stably seated on the ground upon use of the multi-functional cleaner 10.

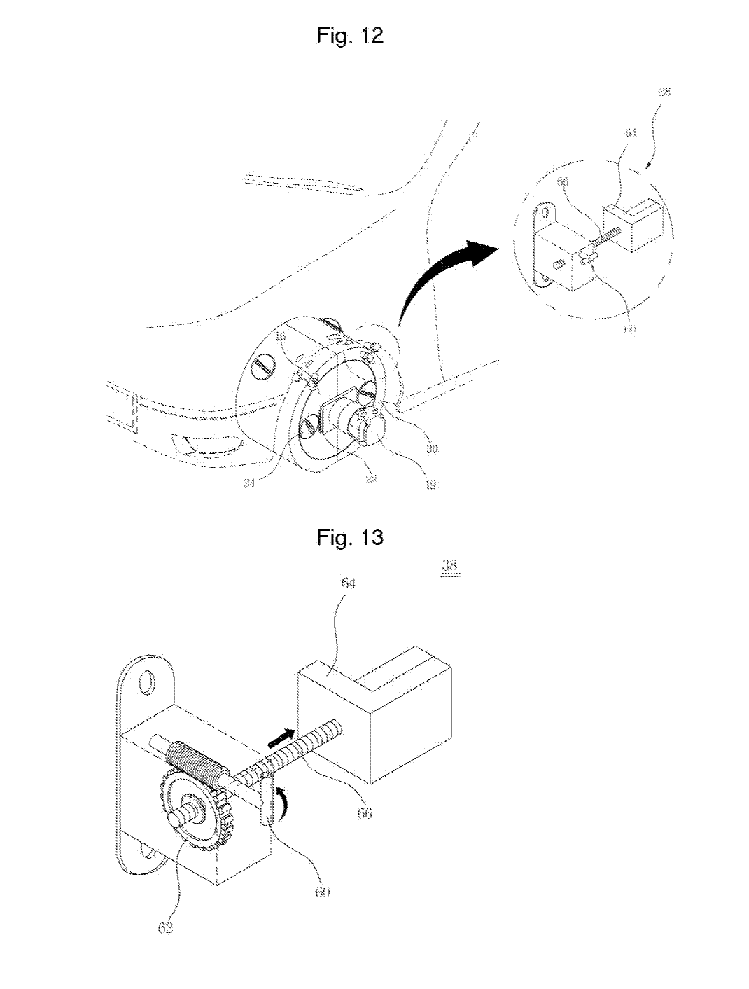

As shown in FIGS. 12 and 13, an adjusting member 38 may be provided on the washing body 16 to prevent shaking that occurs as the driving means 19 rotates, with the tire covered by the washing cap 30.

The adjusting member 34 includes a fastening handle 60, a gear 62, a fastening shaft 66, and a fastening piece 64.

The adjusting member 38 is provided in the washing cap 30. As the fastening handle 60 is rotated, the gear 62 engaged with the fastening handle 60 is rotated, adjusting the length of the fastening shaft 66. Accordingly, the fastening piece 64 coupled with the fastening shaft 66 holds together the washing cap 30 and an end surface of the vehicle, thus offering increased stability upon wheel washing.

As shown in FIGS. 10 to 13, the above components may be not integrally formed but may be formed to be separated from each other, thus allowing for reduced size.

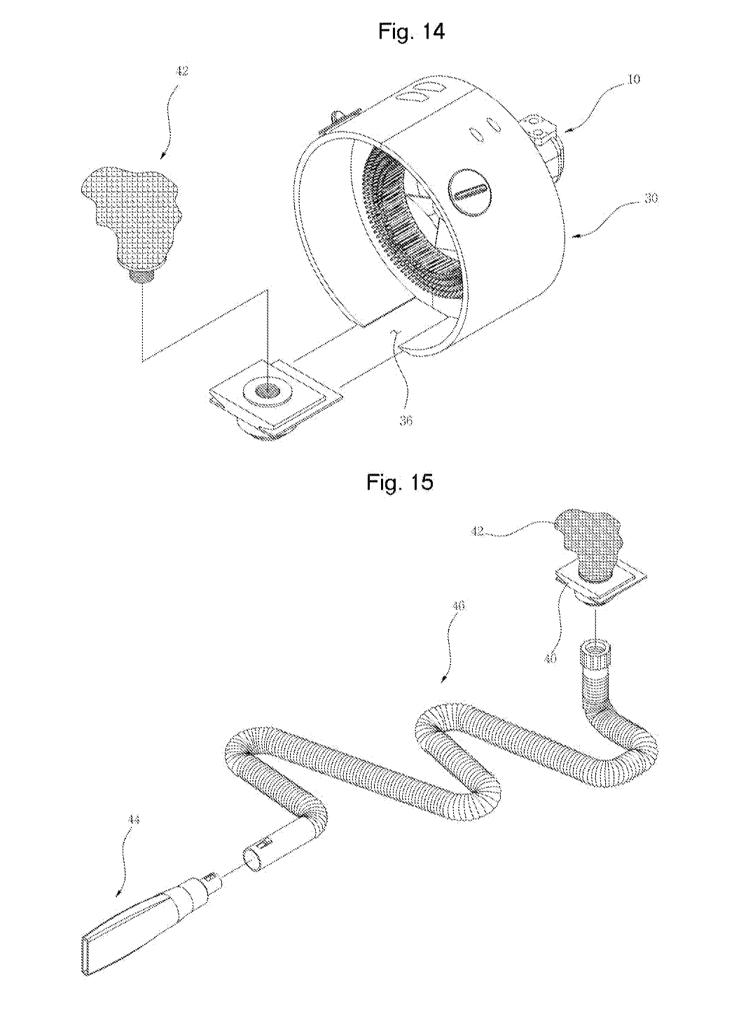

As shown in FIGS. 14 and 15, when the multi-functional cleaner 10 is used as a vacuum cleaner according to an embodiment of the inventive concept, a vacuum plate 40, together with a dust collector 42, may be coupled to the washing cap 30 through the second coupling opening 36.

A cover may be provided on the washing cap 30 coupled with the vacuum plate 40 through the second coupling opening 36 to create a vacuum inside the washing cap 30. The dust collector 42 is coupled at a side of the vacuum plate 40, and a suction hose 46 is coupled at an opposite side of the vacuum plate 40. An intake port 44 is coupled to an end of the suction hose 46. Accordingly, the multi-functional cleaner 10 may function as a vacuum cleaner.

The vacuum plate 40 may be air-tightly coupled to the washing cap 30 through the second coupling opening 36, thus creating a vacuum inside the washing cap 30. The dust collector 42 coupled with the vacuum plate 40 collects dust sucked through the intake port 44 and the suction hose 46. A centrifugal force generated as the disc 14 rotates in a forward or reverse direction in the washing cap 30 turns into a suction force that allows the dust to be drawn through the intake port 44 and the suction hose 46 and to be collected in the dust collector 42. Accordingly, the need for getting rid of the dust filter like the conventional filter-type vacuum cleaner is eliminated.

An embodiment of the inventive concept may provide a vacuum cleaner that may be semi permanently used by just emptying the dust collector 42.

Various types of intake ports 44 may be used for use in a vehicle or home.

A handle or wheel may be formed on a cover provided on a lower end of the washing cap 30 for better manipulation and mobility.

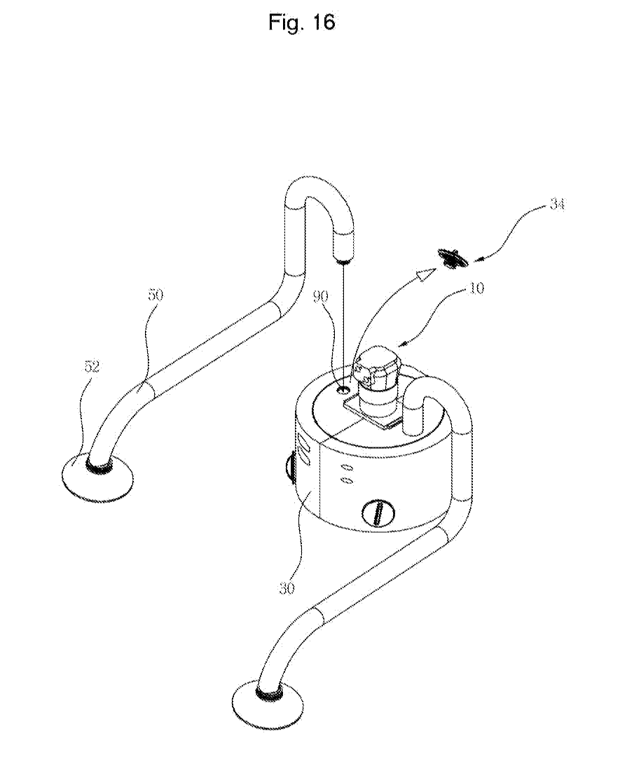

When the multi-functional cleaner 10 is used as a vacuum cleaner as shown in FIG. 16, the caps 34 may be removed from the washing body 16, and two sets each having a vacuum hose 50 and a vacuum pad 52 may be coupled into the cap holes 90. Although two cap holes 90 are formed through the washing body 16 as an example, embodiments of the inventive concept are not limited thereto. According to an embodiment of the inventive concept, more than two cap holes 90 and accordingly more than two sets of vacuum hoses 50 and vacuum pads 52 may be provided.

The vacuum pads 52 may be attached onto left and right sides, respectively, of a wheel or outer surface of a vehicle as the inside of the washing cap 30 is rendered to be in a vacuum.

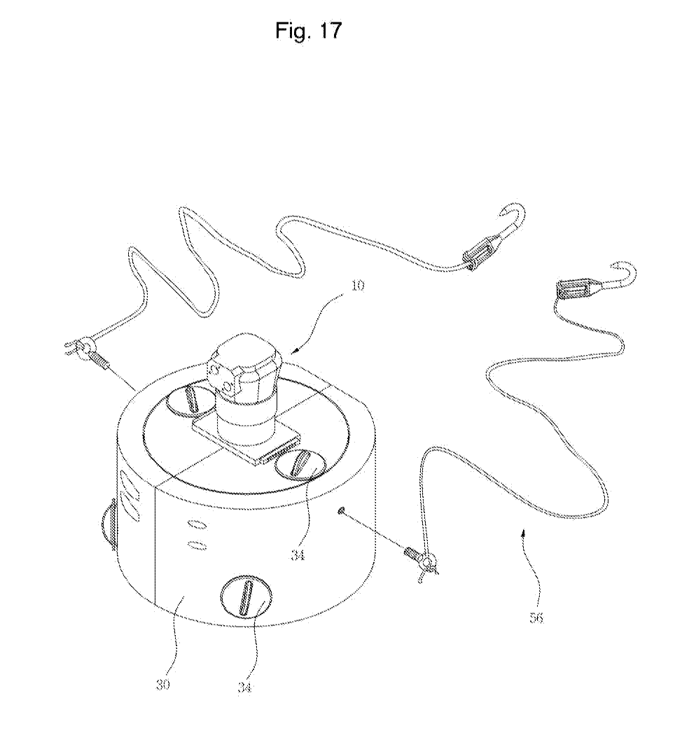

As shown in FIG. 17, two or more wires 56 with hooks at ends thereof may be coupled to the washing cap 30. The wires 56 may be hung at a higher position above the ground, allowing the user easier vacuuming.

According to an embodiment of the present invention, the multi-functional cleaner may allow the user to perform cleaning or washing without dust scattering problem.

According to an embodiment of the present invention, the multi-functional cleaner may function as a vacuum cleaner as well as perform wheel washing and polishing.

According to an embodiment of the present invention, the components of the multi-functional cleaner may be easily separated from each other, thus offering easier replacement of the parts while saving the accommodation space. The multi-functional cleaner may provide various other functions.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A multi-functional cleaner comprising:
a driving means having a motor to generate a dynamic force;
an output shaft projected from the driving means through a center of a washing body having a first cap hole into which a dust collector or a cap may be detachably coupled, a driving gear coupled to the output shaft;
a disc coupled to the driving gear; and
a brush member coupled to the disc, wherein the output shaft is rotated to rotate the disc, and wherein as the cap is coupled into the first cap hole, an inside of the washing body is prevented from being exposed.

2. The multi-functional cleaner of claim wherein the washing body further includes a second cap hole, a plurality of vacuum hoses coupled into the first cap hole and the second cap hole, respectively, and wherein a plurality of vacuum pads are coupled to respective ends of the plurality of vacuum hoses.

3. The multi-functional cleaner of claim 1, wherein the driving means includes two or more second fastening pins, and the washing body includes two or more pin holes through which the second fastening pins may be inserted to fasten the washing body to the driving means.

4. The multi-functional cleaner of claim 3, wherein a spring is provided between the driving means and each of the second fastening pins.

5. The multi-functional cleaner of claim 1, wherein a first fastening pin is provided to allow the disc to be attached to the driving gear or to be detached from the driving gear, and wherein a spring is provided under the first fastening pin.

6. The multi-functional cleaner of claim 1, wherein a first coupling part is protruded from an outer circumferential surface of the washing body to allow a washing cap to be coupled to the washing body, the washing cap including two parts that may be separated from each other with respect to a central line, wherein the washing cap includes a detergent inserting hole through which a detergent may be introduced from an outside, and wherein a packing and a cap are sequentially coupled into the detergent inserting hole to prevent the detergent from leaking out.

7. The multi-functional cleaner of claim 3, wherein two adjusting members are further provided at two sides of the washing cap, each of the adjusting members having a fastening handle, a gear engaged with the fastening handle, a fastening shaft coupled with the gear through a center of the gear, and a fastening piece coupled with an end of the fastening shaft, and wherein each adjusting member is configured so that as the fastening handle is rotated, the gear is rotated to induce the fastening shaft to move forwards or rearwards such that the fastening piece is tightly fastened to a frame of an adjacent vehicle to prevent the washing cap from moving.

8. The multi-functional cleaner of claim 3, wherein the washing cap includes a second coupling opening for coupling with a vacuum plate, the vacuum plate having a first side coupled with a dust collector and a second side opposite the first side, the second side of the vacuum plate coupled with a suction hose, and wherein an intake port is coupled to an end of the suction hose.

9. The multi-functional cleaner of claim 3, wherein the washing cap includes two or more wires each having a hook at an end thereof.
